(19) United States
(12) Patent Application Publication
(10) Pub. No.: US 2026/0192306 A1
(43) Pub. Date: Jul. 9, 2026

(54) APPARATUS TO REDUCE METAL PIECES INTO FRAGMENTS

(71) Applicant: IKOI S.P.A., Tezze sul Brenta (VI) (IT)

(72) Inventors: Giovanni Faoro, Bassano Del Grappa (VI) (IT); Ilario Munari, Rosa' (VI) (IT); Eros Munari, Rosa' (VI) (IT)

(21) Appl. No.: 19/130,878

(22) PCT Filed: Nov. 14, 2023
(86) PCT No.: PCT/IB2023/061486

§ 371 Date: May 16, 2025

(30) Foreign Application Priority Data
Nov. 16, 2022 (IT) 102022000023649

(51) Int. Cl. B02C 18/14; B02C 13/28; B02C 13/286; B02C 18/22

(52) U.S. Cl. CPC B02C 18/14; B02C 13/28; B02C 13/286; B02C 18/22

(57) ABSTRACT

An apparatus (10) to reduce metal pieces into fragments, comprising a supporting and containing structure (11) of: a feeding assembly (12) of metal pieces (P) to be reduced into fragments; a supporting plane (13) adapted to receive the metal pieces (P) fed by the feeding assembly (12) and developing longitudinally between a first end (13a) and a second end (13b) opposite to each other; a pusher assembly (14) disposed in proximity of the first end (13a) and adapted to exert on the metal pieces (P) fed and lying thereon a thrust towards the second end (13b) along a thrust direction (A-A) extending between the first end (13a) and the second end (13b); a drum (15) rotatably supported around its longitudinal axis (B-B) in proximity of the second end (13b) and provided with a plurality of teeth (16) which are arranged on its outer side surface (151) and which are adapted to remove fragments from the metal pieces (P) pushed against it by the pusher assembly (14) via chip removal, wherein the drum (15) is rotationally drivable around its longitudinal axis by a motor element (17); a presser assembly (18) disposed above the supporting plane (13) in proximity of the second end (13b) thereof and adapted to exert on the metal pieces (P) pushed by the pusher assembly (14) a pressure force with a component incident and directed towards the supporting plane (13); a collector assembly (19) of the fragments disposed below the drum (15).

The present invention relates to an apparatus to reduce metal pieces into fragments.

The present invention also relates to a method and a plant for treating metal pieces.

Metal pieces mean, for example, pieces made of pure gold, or silver, or alloys thereof, pieces made of copper, or aluminium, or alloys thereof, or the like.

The metal pieces can have, particularly but not exclusively, the form of standard and compliant rods, whether they are scrap rods or new rods, or the like, which need to be reduced to fragments suitable for subsequent processing and production.

Scrap metal pieces made of pure gold, silver, copper, or aluminium (i.e., pure in the range 99%-99.99%), or alloys thereof are intended to indicate, for example, processing scraps, rods, or ingots not meeting the effective quality standards or scrapped from the production processes, processing scraps in the form of large blocks, blocks, offcuts, clippings, shavings, or the like, anodes/cathodes used in electrochemical processes, or the like.

New and/or compliant (i.e., not scrap) metal pieces are intended to indicate, for example, new standard and compliant rods, made of gold, silver, copper, aluminium, alloys or thereof which are purchased for example by refiners as a raw material for producing rods, ingots, coins of smaller size and which, for this purpose, need to be reduced to fragments.

Currently, there are two technologies for treating such metal pieces, whether they are scrap or new and compliant (for example rods), and reintroducing them in the market or in the production processes:
According to a first technology, such metal pieces are used to produce so-called “bank rods”, for example (“Standard London Good Delivery”) weighing 1000 oz (about 31.1 Kg weight+/−5%), ready for the market. For this purpose, the metal pieces are melted, and the melted metal is then cast in dedicated moulds shaped and sized for producing such “bank rods.”
According to a second technology, the metal pieces, whether they are scrap or new and compliant (for example rods), are used to produce grit, which is then used in subsequent industrial processes for producing ingots, rods, coins, semi-finished products, and the like. For this purpose, the metal pieces are melted, and the melted metal is cast in water through a so-called “sprue” so as to form grit. The grit is then used as a material for feeding plants for producing ingots, rods, coins, semi-finished products, and the like.

In both cases, treating the metal pieces involves a melting process, resulting in disadvantageous energy waste both economically and environmentally.

The technology for producing the so-called “bank rods”, in addition to being energetically disadvantageous, requires the use of operators, resulting in labour costs and risks for their physical safety.

In the field of scrap material recovery in general, apparatuses to reduce scrap pieces into fragments consisting of so-called single-shaft, two-shaft, or even four-shaft shredders or crushers are already known, wherein each rotating shaft a has plurality of blades or shears which clearly cut or shear the pieces in multiple parts, without producing shavings. These known shredders are also used to reduce metal scrap pieces into fragments, generally scraps made of iron, aluminium, or copper, but never in the form of solid large blocks from melting, such as rods.

It was experimentally tested that these known shredders or crushers are not suitable to reduce metal pieces into fragments as identified above (for example rods made of gold, silver, copper, or aluminium) in order to reduce the latter to fragments with sizing useful, in form, size, and apparent specific weight, for a subsequent use thereof as materials for feeding plants for producing ingots, rods, coins, semi-finished products, and the like.

The known shredders or crushers have been shown not to be particularly suitable to reduce metal pieces made of pure gold, silver, copper, or aluminium, or alloys thereof, having the form of rods or ingots having various size and weight, such as for example “bank rods”, to fragments with sizing useful, in form, size, and apparent specific weight, for a subsequent use thereof as materials for feeding plants for producing ingots, rods, coins, semi-finished products, and the like.

An aim of the present invention is to provide an apparatus to reduce metal pieces, also in the form of rods or ingots having various size and weight (such as for example “bank rods” of about 31.1 kg and/or with thicknesses between 20 mm and 90 mm), into fragments which allows to overcome the drawbacks of the prior art.

Another purpose of the present invention is to provide an apparatus which allows to reduce metal pieces, even in the form of ingots or rods having various size and weight (such as for example “bank rods” of about 31.1 kg), into fragments with sizing useful, in form, size, and apparent specific weight, for a subsequent use thereof as materials for feeding plants for producing ingots, rods, coins, semi-finished products, and the like.

Another purpose of the present invention is to make a particularly simple and functional low-cost apparatus to reduce metal pieces into fragments.

Another purpose of the present invention is to make a method and a plant for treating metal pieces, for example pieces made of pure gold, silver, copper, or aluminium, or alloys thereof, which is advantageous in terms of energy, environment, and safety.

These purposes according to the present invention are achieved by making an apparatus to reduce metal pieces into fragments as set forth in claim 1.

Further features are provided in the dependent claims.

These purposes according to the present invention are also achieved by a method and a plant for treating metal pieces as set forth in claims 22 and 23.

The features and advantages of an apparatus to reduce metal pieces into fragments and of a method and a plant for treating metal pieces, according to the present invention will be more apparent from the following exemplary and non-limiting description referred to the attached schematic drawings in which:

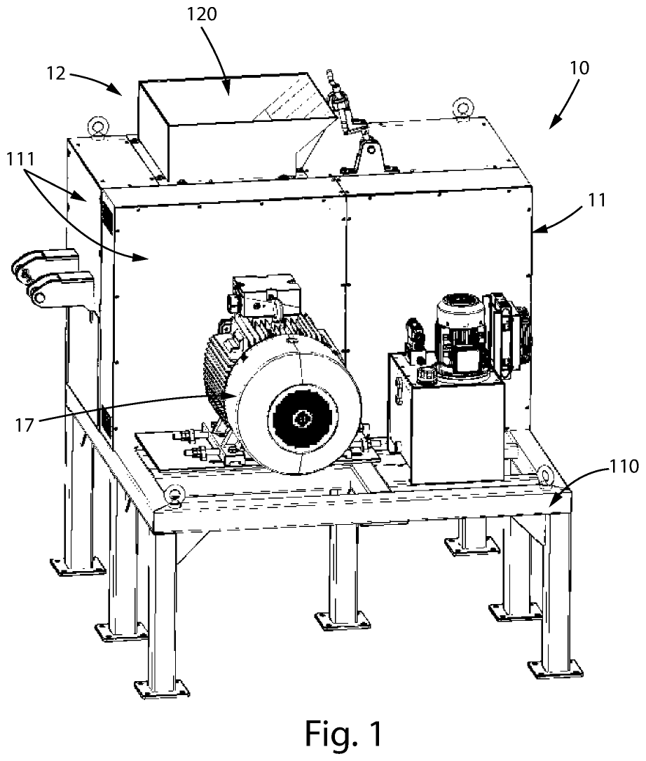

FIG. 1 is an axonometry view of a possible embodiment of the apparatus to reduce metal pieces into fragments according to the present invention;

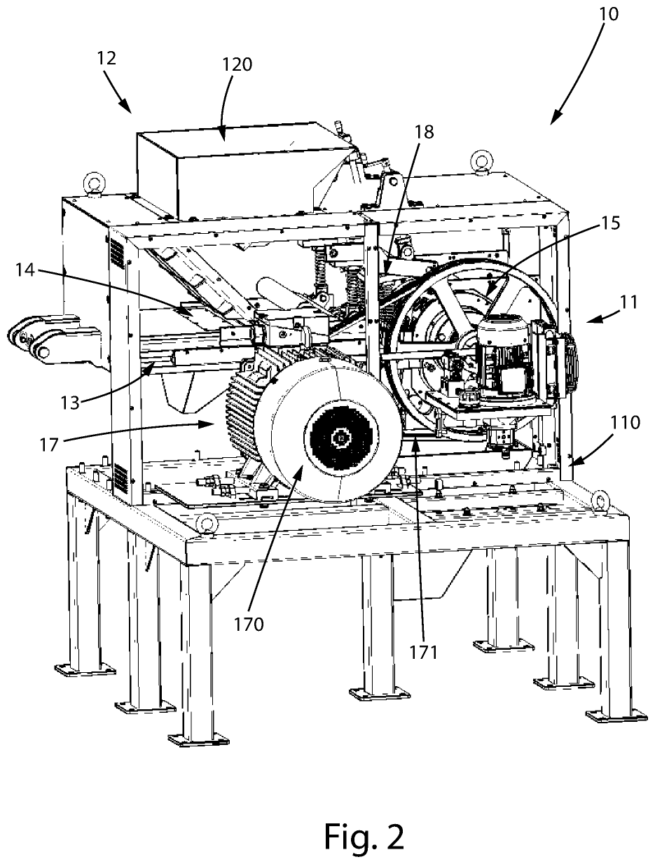

FIG. 2 shows the apparatus of FIG. 1 from which covering components have been removed to make the inside thereof visible;

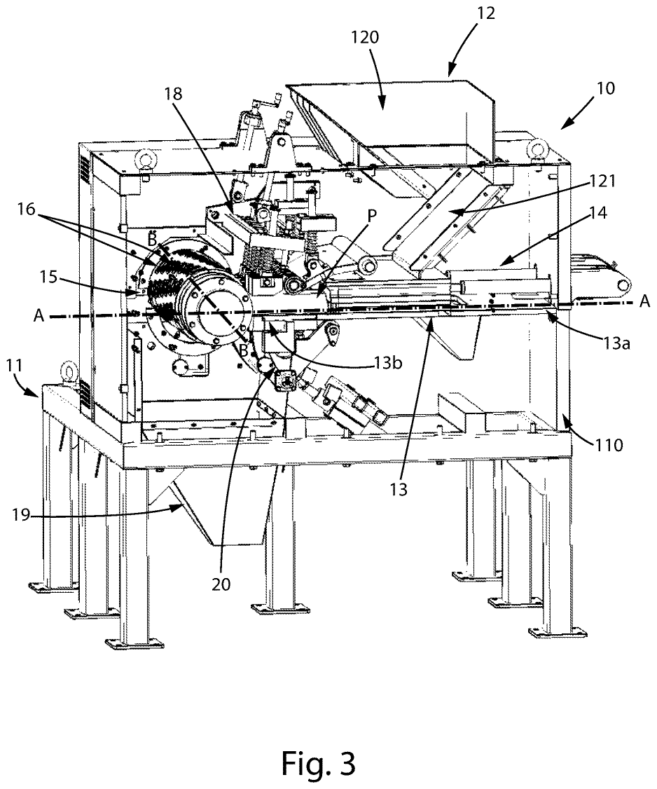

FIG. 3 is a view as that of FIG. 2, but on the opposite side with respect to it;

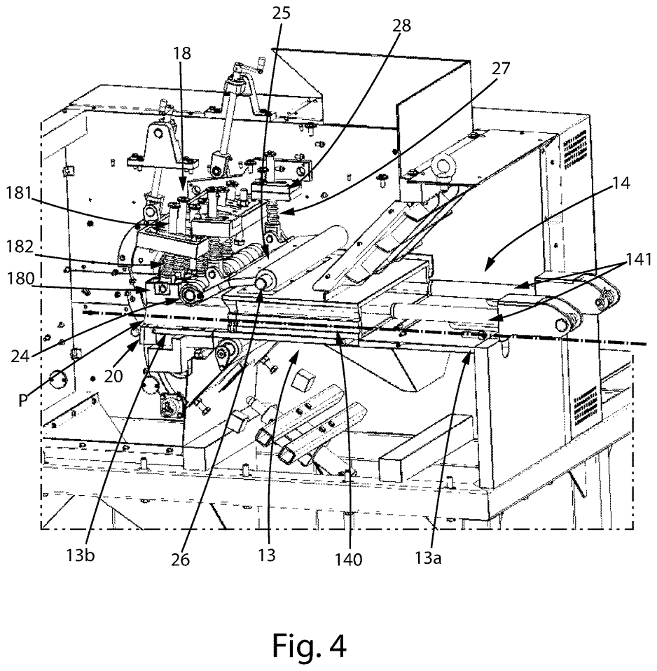

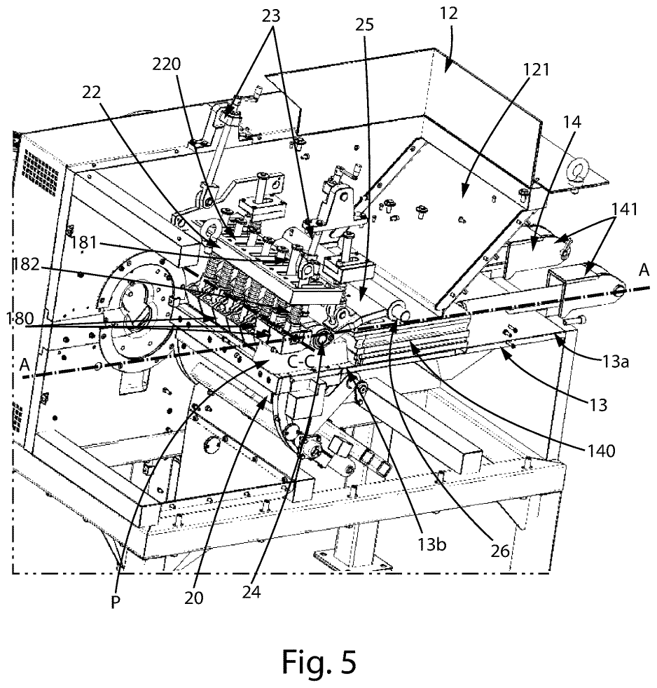

FIGS. 4 and 5 show, from two different angles, a detail of FIG. 3 consisting of the assembly comprising the supporting plane, the feeding assembly, the pusher assembly, and the presser assembly of the apparatus of FIGS. 1-3 from which other components including the drum have been removed;

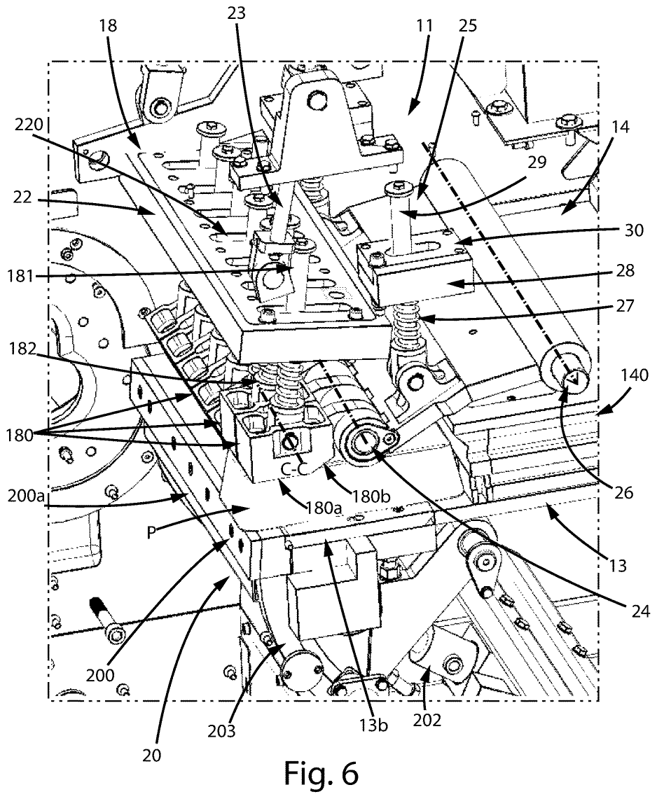

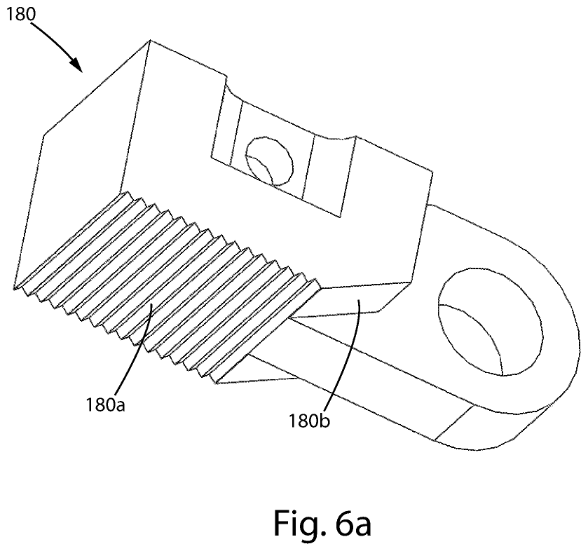

FIG. 6 shows on an enlarged scale the presser assembly and the supporting plane of the apparatus of FIGS. 1-5;

FIG. 6A shows a detail of the presser assembly;

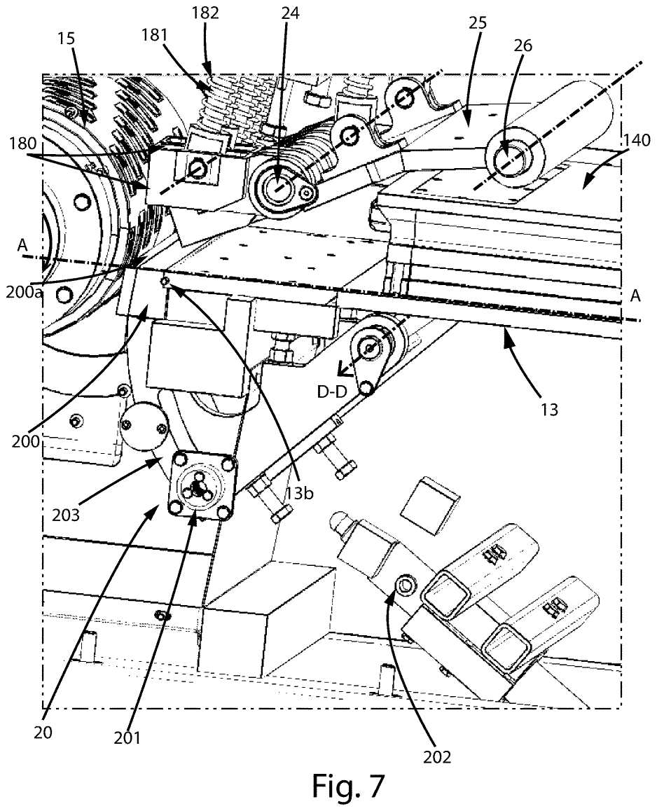

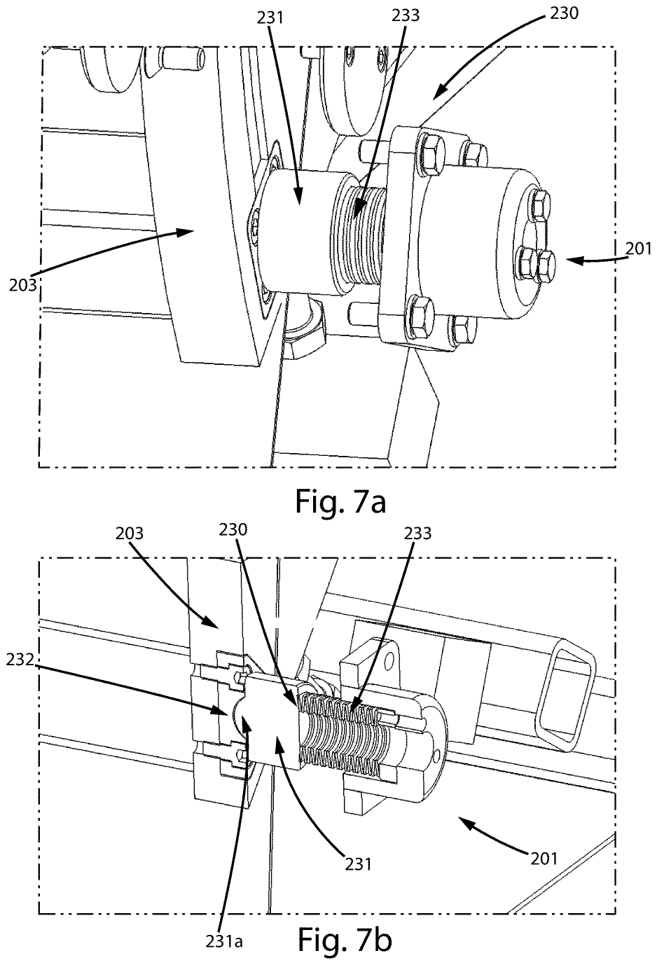

FIG. 7 shows on an enlarged scale and according to a different angle the detail of FIG. 6 complete with drum;

FIGS. 7A and 7B show in axonometry and in section a detail of the removal assembly of FIG. 7;

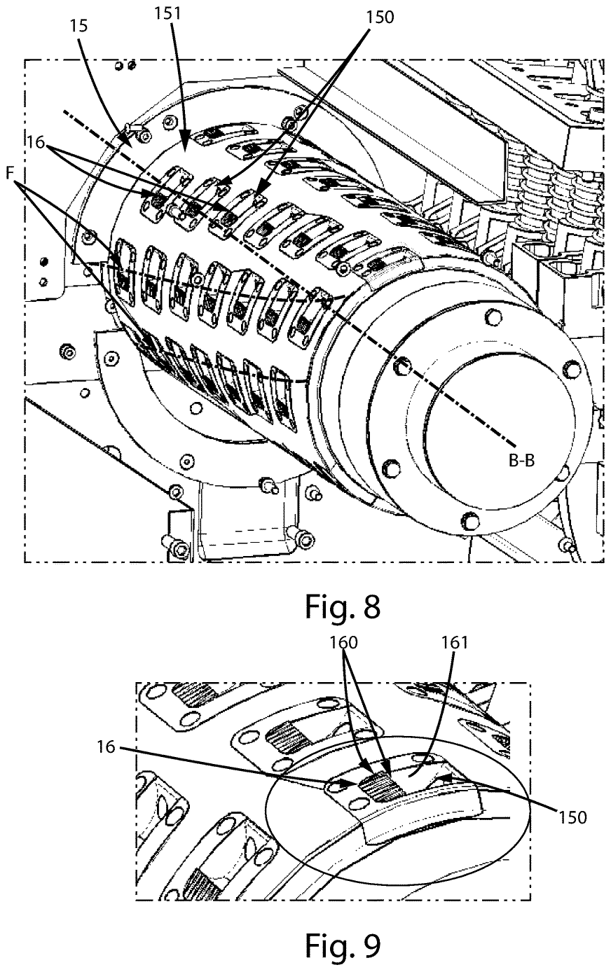

FIG. 8 shows the drum of the apparatus of FIGS. 1 to 7;

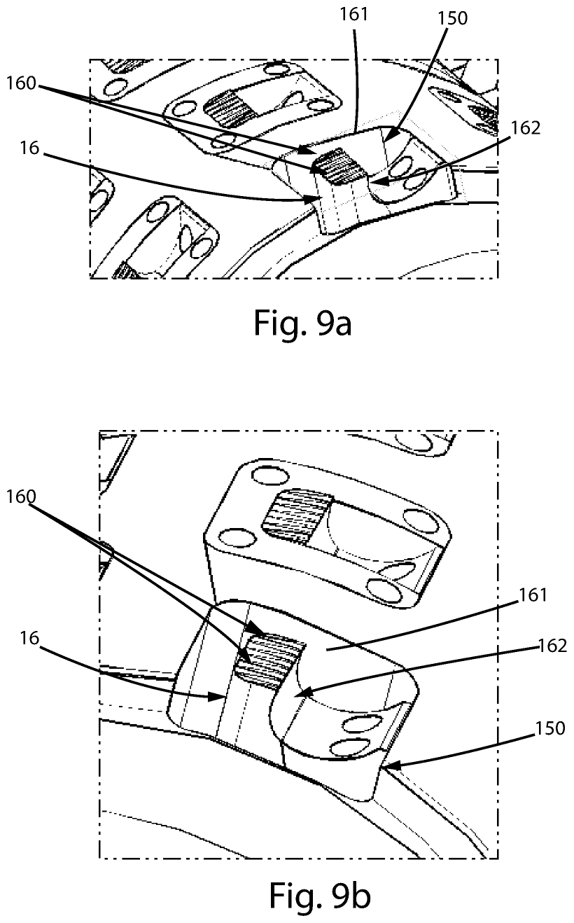

FIG. 9 shows on an enlarged scale a tooth of the drum of FIG. 8;

FIGS. 9A and 9B show from two different angles a detail of the tooth of FIG. 9;

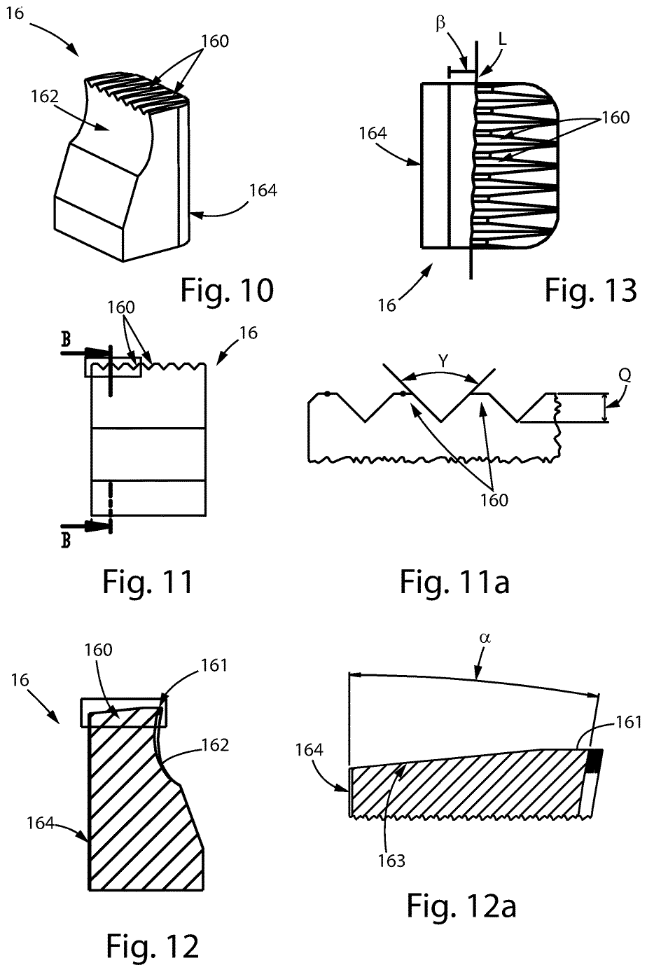

FIG. 10 is a view in axonometry of a tooth;

FIG. 11 is a front view of FIG. 10;

FIG. 11A is a detail on an enlarged scale of FIG. 11;

FIG. 12 is the section according to the plane indicated in FIG. 11;

FIG. 12A is a detail on an enlarged scale of FIG. 12;

FIG. 13 is a top plant view of the tooth of FIG. 10;

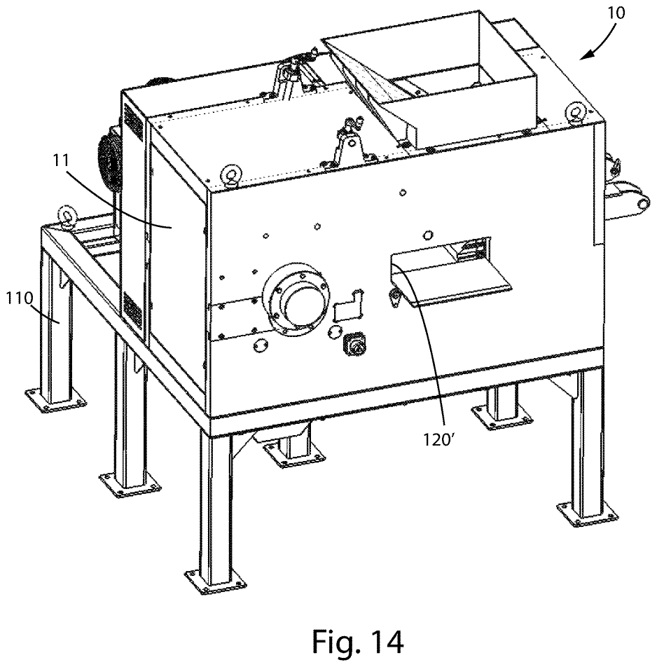

FIG. 14 shows a possible alternative embodiment of the apparatus to reduce metal pieces into fragments.

With reference to the attached figures, an apparatus 10 to reduce metal pieces into fragments is shown.

As already indicated, metal pieces mean, for example, pieces made of pure gold or silver or alloys thereof, pieces made of copper or aluminium or alloys thereof, or the like.

The metal pieces to be treated can be scrap pieces or not, i.e., pieces forming a raw material compliant with subsequent processing.

Scrap metal pieces are intended to indicate for example:
processing scraps,
rods or ingots not meeting the effective quality standards or scrapped from the production processes,
processing scraps in the form of large blocks, blocks, offcuts, crop-ends, shavings, or the like,
anodes/cathodes used in electrochemical processes, or the like.

New and/or compliant (i.e., not scrap) metal pieces are intended to indicate, for example, new standard and compliant rods, made of gold, silver, copper, aluminium, or alloys thereof which are purchased for example by refiners as a raw material for producing rods, ingots, coins of smaller size which, for this purpose, need to be reduced to fragments.

Particularly, metal pieces made of pure gold or silver are intended to indicate rods or ingots having various size and weight such as for example so-called “bank rods” having a weight equal to about 31.1 kg and size of about 285 mm×140 mm×85 mm, depending on the manufacturer and the reference standards, and rods or ingots with thicknesses between 20 mm and 90 mm.

Pure gold or silver are intended to indicate gold or silver respectively at min. 99%.

In the attached figures, a metal piece P in the form of a rod or ingot is shown only by way of example.

As will be from the following apparent description, the apparatus 10, in contrast to known shredders or crushers, does not make a clear cut or shear of the pieces in fragments having smaller size by means of knives or shears, but works via material removal in the form of fragments of the shavings type, i.e., operates via chip removal.

The apparatus 10 comprises a supporting and containing structure 11 of:
a feeding assembly 12 of metal pieces P to be reduced into fragments (for the sake of simplicity referred to as “pieces P” below);
a supporting plane 13 adapted to receive the pieces P fed by the feeding assembly 12 and developing longitudinally between a first end 13a and a second end 13b axially/longitudinally opposite to each other;
a pusher assembly 14 disposed in proximity of the first end 13a of the supporting plane 13 and adapted to exert on the pieces P lying thereon a thrust towards the second end 13b thereof along a thrust direction A-A extending between the first end 13a and the second end 13b of the supporting plane 13;
a drum 15 rotatably supported around its longitudinal axis B-B in proximity of the second end 13b of the supporting plane 13 and provided with a plurality of teeth 16 or blades which are arranged on its outer side surface and which are adapted to work via chip removal to remove fragments from the pieces P which are pushed against it by the pusher assembly 14, in which the drum 15 is rotationally drivable around its longitudinal axis B-B by a motor element 17;
a presser assembly 18 disposed above the supporting plane 13 in proximity of the second end 13b of the latter and adapted to exert on the pieces P pushed by the pusher assembly 14 a pressure force with a component incident and directed towards the supporting plane 13;
a collector assembly 19 of the fragments removed from the pieces P by the teeth 16 disposed below the drum 15.

In the attached figures the apparatus 10 is shown with the supporting plane 13 disposed horizontally, however, alternative embodiments in which, for example, the supporting plane 13 is inclined to the horizontal or even disposed vertically are not excluded.

Advantageously, the apparatus 10 can comprise a removal assembly 20 for removing from the drum 15 the offcuts-residuals of the pieces P in the comminution step not further reducible to fragments by the teeth 16. Such removal assembly 20 is disposed in proximity of the second end 13b of the supporting plane 13 and is configured to automatically intervene when the offcuts-residuals of the pieces P in the comminution step reach a definite size, particularly in terms of residual thickness, or however are such as to be no longer suitable to be reduced into fragments by the teeth 16.

The supporting and containing structure 11 comprises a frame 110 provided with ground stands, outer 111 and inner removable carters defining compartments in which the various components are housed.

In the shown embodiment, the supporting plane 13 is disposed substantially horizontal, or parallel to the plane on which the frame 110 lies and develops in length between the first end 13a thereof and the second end 13b thereof axially or longitudinally opposite to each other.

The feeding assembly 12 which, in the exemplified embodiment, comprises a hopper or feeding mouth 120 accessible from outside below which there is a ramp 121 disposed to accompany the drop by gravity of pieces P to be reduced into fragments on the supporting plane 13 is disposed above the supporting plane 13.

In a possible alternative embodiment shown in FIG. 14, the feeding assembly 12 can be disposed laterally to the supporting plane 13. In such a case, the feeding mouth 120′ is obtained on one side of the supporting plane 13 and a feeding plane, on which the pieces P are resting and slid entering the apparatus 10, is present externally thereto.

The pusher assembly 14 is disposed in proximity of the first end 13b of the supporting plane 13 and comprises at least one skid 140 extending transversally to the supporting plane 13 and which is slidable while lying thereon along the thrust direction A-A, parallel to the longitudinal development of the supporting plane 13 itself.

The skid 140 is coupled to at least one linear actuator 141 adapted to move it in sliding motion along the thrust direction A-A in both the directions. In the shown embodiment, the skid 140 extends over the entire width of the supporting plane 13 and is coupled to the end of the stems of two linear actuators 141 for example in the form of a pneumatic cylinder-piston unit extending parallel to the thrust direction A-A. Obviously, the linear actuators 14 can be differently made and be of the motorized type.

The skid 140 is movable between at least one backward position, in which it is disposed in proximity of the first end 13a of the supporting plane 13 backward, with respect to the thrust direction, to the pieces P to be reduced into fragments thereon fed by the feeding assembly 12, and at least one forward position, in which it is put forward towards the second end 13b of the supporting plane 13 by pushing the pieces P along the thrust direction A-A towards it so as to press them against the drum 15.

In the attached figures, the skid 140 is shown in a forward position in which it pushes a piece P in the form of a rod or ingot against the drum 15.

The presser assembly 18 is disposed above the supporting plane 13, in proximity of the second end 13b thereof, that is in an intermediate position between the drum 15 and the feeding assembly 12.

The presser assembly 18 is configured to keep the pieces P lying on the supporting plane 13 while they are pushed by the pusher assembly 14 against the drum 15.

The presser assembly 18 is thus configured to exert on the pieces P a thrust force having at least one component orthogonal or incident to the supporting plane 13.

Advantageously, the presser assembly 18 is configured to exert on the pieces P a differentiated thrust force as a function of their form and/or their size.

Particularly, the presser assembly 18 is configured to exert on the pieces P a differentiated thrust force as a function of the profile which the pieces P, individually as a or whole, have transversally to the supporting plane 13, and/or as a function of the height which the pieces P, individually or as a whole, have in a direction orthogonal to the supporting plane 13, and/or the degree of compaction of an assembly of loose pieces P.

That is, the presser assembly 18 is configured to adapt to the different shape which the single pieces P or an accumulation of pieces P, pushed by the pusher assembly 14 against the drum 15, can assume in terms of form or profile and/or size and/or compaction, so as to exert a differentiated thrust force on them, individually or as a whole.

The presser assembly 18 comprises at least one block 180 adapted to contact the pieces P and which is coupled to the end of a respective stem 181, which is slidably supported along its axis in contrast with elastic pushing means 182 on a plane orthogonal to the supporting plane 13 and parallel to the thrust direction A-A. Each stem 181 is disposed with its axis orthogonal or incident to the supporting plane 13.

Each block 180 consists of a skid or the like having a substantially prismatic form with a substantially flat lower face 180a resting on the pieces P, which can be smooth and/or knurled as shown in FIG. 6A, and with a chamfered inlet edge 180b (FIG. 6).

Each block 180 is rotatably jointed at the lower end of the respective stem 181 means of a by cylindrical hinge so as to swing around a joint axis C-C parallel to the supporting plane 13 and orthogonal to the thrust direction A-A.

Each stem 181 is supported by a support plate 22 anchored to the structure 11 in an advantageously height adjustable manner by means of dedicated adjustable beams 23.

As can be seen in the attached figures, each stem 181 is inserted with clearance in a corresponding slot 220 of the support plate 22.

The elastic pushing means 182 consist for example of one or more coil springs coaxial to the stem 181 and operating between the lower end thereof and a matching part anchored below the support plate 22 and not visible in the attached figures.

In an advantageous embodiment, the presser assembly 18 comprises a plurality of blocks 180 distinct and independent to each other disposed in succession side by side so as to form a row extending in proximity of the second end 13b of the supporting plane 13 along a direction parallel thereto and orthogonal to the thrust direction A-A.

In a preferred embodiment, each block 180 is further rotatably jointed around a first pin 24 which is supported above the supporting plane 13 between the first end 13a and the second end 13b of the latter and which is disposed with its axis parallel to the joint axis C-C of the block 180 itself to the respective stem 181 and upstream of it with respect to the drum 15.

The first pin 24, or the joint axis defined thereby, is common to all the blocks 180 and is movably supported with respect to the structure 11 so as to make excursions along directions transversal to the supporting plane 13.

In the embodiment shown in the attached figures, the first pin 24 is supported at the end of an inlet plate 25, whose opposite end is rotatably jointed around a second pin 26 which is fixed to the structure 11 and which is also disposed above the supporting plane 13 between the first end 13a and the second end 13b thereof and upstream of the first pin 24.

The inlet plate 25 is rotatable around the second pin 26 in contrast with respective elastic pushing means 27 acting between it and a contrast element 28 fixed to the structure 11. The elastic pushing means 27 consist for example of springs coaxial to a respective guide stem 29 having one end jointed to the inlet plate 25 and the opposite end accommodated in the slot of a supporting body 30 fixed to the structure 11.

The second pin 26 is disposed at an height with respect to the supporting plane 13 higher than that at which the first pin 24 is when there are no pieces P on the supporting plane 13, i.e., when the elastic pushing means 27 are in their lower stress state (compression).

The height at which the second pin 26 is fixed is sized so as to allow both the skid 140 and the pieces P to be reduced into fragments to pass below it and the inlet plate 25.

As can be noted from FIGS. 5 and 6, when a piece P discharged from the feeding assembly 12 on the supporting plane 13 is pushed by the pusher assembly 14 towards the drum 15, it firstly meets the inlet plate 25 by arranging below it and possibly raising it, rotating it around the second pin 26.

Only the blocks 180 interested by the piece P (the first two in figure) are raised in contrast with the respective elastic pushing means 182 rotating around the first pin 24 and thus being disposed lying on the upper surface of the piece P.

The remaining blocks 180, i.e., those not interested and not met by the piece P, remain lying on the supporting plane 13, ready to accommodate below them another piece to be reduced into fragments having form and size even different from that being processed below the first blocks 180.

The removal assembly 20 is disposed downstream of the second end 13b of the supporting plane 13.

Such removal assembly 20 comprises at least one bar 200 provided with an upper surface 200a forming a supporting surface of the pieces P being processed and the offcuts-residuals thereof. The bar 200 is movably coupled to the structure 11 between a raised position and at least one lowered position. In the raised position, the bar 200 is side by side with the second end 13b of the supporting plane 13 with the upper surface 200a thereof substantially coplanar and contiguous with the upper surface e of the supporting plane 13 to support the pieces P being processed or the residuals thereof.

In the lowered position, the bar 200 is moved away from the second end 13b of the supporting plane 13 and disposed below the latter, clearing a space for dropping of the offcuts-residuals of the pieces P being processed.

The bar 200 is held in its raised position by respective holding means, for example friction, elastic pushing means 201 or equivalents thereof, and is movably driven from its raised position to the at least one its lowered position by the opposite thrust thereon exerted by the residuals of the pieces P being processed dragged by the drum 15.

When a piece P, for example in the form of a rod, has been almost completely reduced into fragments until becoming a offcut-residual, particularly a offcut-residual having a thickness comprised in the range 5 mm
10 mm, the latter could have two behaviours:
managing to be reduced into fragments down to such a thickness to pass through the hole between the bar 200 and the drum 15 dropping in the collector assembly 19 without the removal assembly 20 being activated, or
starting vibrating and “jumping” without the teeth 16 managing to operate thereon by removal and exerting on the rod 200 a thrust and pressure force; when the piece P reach the last millimetres in the form of a offcut-residual, it has no longer the size so as to be held in position by the presser assembly 18 and starts vibrating, causing the thrust-pressure exerted on the rod 200 to increase and cancelling the removing effect by the teeth 16. In this situation, a stall condition could be generated: there is no more removal due to the vibration of the offcut-residual of the piece P, but since there is no more removal, the offcut-residual of the piece P remains within the zone between the drum 15, the presser assembly 18 and the supporting plane 13 keeping rotating generating vibrations and noise. In this situation, there is an increase in the thrust-pressure exerted by the residual-offcut of the piece P on the supporting plane 13. The removal assembly 20 is configured to use this thrust-pressure to move away the offcut-residual of the piece P in stall. When such thrust-pressure exceeds a predefinable limit threshold value, indeed, the bar 200 is moved from the raised position thereof to the lowered position thereof so as to drop the offcut-residual of the piece P in the collector assembly 19.

Obviously, this stall phenomenon does not occur when the piece P, for example in the form of a rod, has a size so as to be firmly held by the presser assembly 18, generally until the piece P is reduced to a offcut-residual having size of 5 mm-10 mm of thickness.

Therefore, the bar 200 is movably driven from the raised position thereof to the lowered position thereof by the opposite thrust thereon exerted by the residuals of the pieces P being processed dragged by the drum 15, when the latter pieces reach a preset minimum thickness substantially equal to the thickness of the bar itself 200, for example a thickness in the range 5 mm-10 mm, or however a size such that the offcut-residual, if starts vibrating, is capable of exerting on the bar 200 a downward thrust/pressure such as to overcome the force by which it is held in the raised position.

Then, actuator elements 202 adapted to bring back the bar 200 from the lowered position thereof to the raised position thereof are provided. In the shown embodiment, the actuator elements 202 comprise a linear actuator disposed to operate on the lever 203 when the bar 200 is in the lowered position thereof.

In the exemplified embodiment, there is a single bar 200 formed by a plate extending over the entire width of the supporting plane 13 and which, in the raised position thereof, abuts against the second end 13b thereof.

The bar 200 is fixed to the end of a lever 203 rotatably supported by the structure 11 around a rotation axis D-D so as to move from the raised position thereof to the lowered position thereof by rotation around such rotation axis D-D.

With reference to the exemplified embodiment, the holding means are friction or elastic pushing means 201 and comprise, on each side of the lever 203, a respective pusher 230 mounted on the structure 11 and whose head 231 is inserted by thrust in a corresponding seat 232 integral with the lever 203.

The pusher 231 comprises the head 231 which, on the face facing the lever 203, or better the respective side of the lever 203, has a projection 231a which is inserted in a corresponding seat 232 integral with the lever 203, or vice versa, and which, on the opposite face, has a housing in which a pack of thrusting springs 233 (for example Belleville, coil, or other springs) is accommodated. The projection 231a and the seat 232 have complementary forms, in the example the projection 231a is hemispherical and the seat 232 is correspondingly hemispherical.

The pack of springs 233 acts between the head 231 and a matching part integral with the structure 11 and is sized such that when the bar 200 is in the raised position, the springs 233 exert on the head 231 a thrust towards the corresponding side of the lever 203 so as to hold the projection 231a engaged with the seat 232, so as to hold the lever 203 and with it the bar 200 in the raised position as long as the thrust or pressure exerted thereon by the pieces P being processed is less than a threshold value, i.e., the value of the elastic pushing exerted on the head 231 by the springs 233.

When the residual of the piece P reaches a size so as to be no longer firmly held by the presser assembly 18 and to be processed by the teeth 16, it starts vibrating and “jumping” exerting on the bar 200 a thrust and pressure force which, once exceeded the thrust exerted by the pushers 230, causes the bar 200 to move from the raised to the lowered position. In the embodiment, this occurs when the thrust-pressure exerted by the residuals of the pieces P is such as to exceed the elastic pushing exerted by the springs 233, so as to disengage the head 231 from the seat 232 and to push the bar 200 downward, and with it the lever 203, clearing a space between the drum 15 and the supporting plane 13 from which the residuals of the pieces P drop towards the collector assembly 19.

Then, there is a stroke end sensor of the lever 203 which, when the lever 203 and with it the bar 200 are in the lowered position, activates a timer which, after a given time interval, operates the actuator 202 pushing the lever 203, and with it the bar 200, in the raised position with restoration of the coupling of the pushers 230 with the lever 203.

As can be immediately understood by those skilled in the art, when the lever 203 moves from the raised to the lowered position and vice versa, the head 231 or better its projection 231a slithers, pushed by the springs 233, lying on the sides of the lever 203 itself.

Alternative embodiments of the removal assembly 20 are not excluded, although performing the same function of allowing the bar 200 to move from the raised to the lowered position when the thrust and pressure force exerted thereon by the residuals of the pieces P being processed exceeds a preset threshold value and substantially equal to the holding force which the holding means exert on the lever 203 to keep it in the raised position. Therefore, for example, the springs 233 could be made differently, the pushers 230 could be of the friction type, there could be cam elements and unhooking lever mechanisms, or even unhooking hydraulic, pneumatic, or electromagnetic actuators commanded as a function of the signals outputted by pressure sensors, or even of other type, in place of the pushers 230.

Then, instead of a single bar 200 there could be multiple aligned bars, each operating as described above.

The drum 15 is disposed with its longitudinal axis B-B parallel to the supporting plane 13 and orthogonal to the thrust direction A-A.

The drum 15 is disposed in proximity of the second end 13b of the supporting plane 13. Preferably, it is disposed such that its longitudinal axis B-B is at a height falling within the range of 50 mm above or below (−50 mm-+50 mm) of the supporting plane 13 itself or better the surface although not upper thereof, excluding different possible dispositions.

The drum 15 is rotationally driven by motor elements 17 comprising an electric motor 170 and a drive 171, for example a belt drive.

In the shown embodiment, the drum 15 is rotationally driven in the clockwise direction seeing the FIGS. 3 to 7.

The diameter of the drum 15 is a function of the thickness of the pieces P to be processed; for example, in order to process pieces P in the form of rods with thicknesses between 20 mm and 90 mm, the drum 15 has a diameter of about 300 mm.

A plurality of teeth 16 adapted to remove from the pieces P, pushed by the pusher assembly 14 against the drum 15 and held lying on the supporting plane 13 by the presser assembly 18, fragments in a shavings form, or the like are arranged on the outer side surface of the drum 15 (cylindrical shell 151).

According to the present invention, the drum 15 with its cutting teeth 16 works via chip removal.

With particular reference to FIGS. 9 to 13, the teeth 16 are arranged spaced to each other along a plurality of rows F parallel to each other extending along helix lines.

Each tooth 16 comprises a plurality of cutting sectors 160 identical to each other arranged adjacent to each other and parallel to form a comb.

Each tooth 16 is recessed in a corresponding cavity 150 of the drum 15 so as to protrude from the outer side surface of the drum 15 or better from its cylindrical shell 151 with its cutting profile 161.

Each tooth 16 is disposed in the respective cavity 150 such that the cutting profile 161, or better the cutting profile of each cutting sector 160, protrudes from the outer side surface of the drum 15 (shell 151) of a maximum quota Q between 0.5 mm and 2.0 mm, preferably equal to 1.5 mm (FIG. 11A). This last value was found to be particularly suitable to treat pieces P in the form of rods and profiles made of silver or gold having a purity equal to 99.5%, or 99.9% or 99.99%, of the international size of 1000 Oz (~31.1 Kg) or 15 Kg or of 400 oz (~12.5 Kg) or other size and weighing in general.

Meanwhile, the maximum height Q indicated above allows to minimize the risk that the removed material is kneaded on the teeth 16, to work at a high cutting speed and, especially, to allow to continue processing without drawbacks in the rotation of the drum 15 even when the teeth 16 are in contact with the final offcut-residual of the pieces P, i.e., in the critical moment when the offcut/residual is not perfectly held by the presser assembly 18.

Quotas Q lower than 0.5 mm do not allow a sufficient cut; for quotas Q higher than 2 mm, in the critical moment of the end of the piece P, the teeth 16 contrast with the final offcut-residual with an increase in the friction such as to block the motor for driving the drum 15 by overstraining.

Each cutting sector 160 has the front face of the cutting profile 161 inclined at an angle α between 5° and 15°, preferably equal to 10°, with respect to the flat back face 164 of the tooth 16. Such inclination is crucial for the cutting operation.

Downstream of the cutting profile 161, each cutting sector 160 has a drain 163, a lowering with respect to the plane contacting the material which promotes the removal of the cut material.

Then, it should be noted (FIG. 13) that the cutting sectors 160 of each tooth 16 have, top plant viewed, the outlet end (i.e., that opposite to the cutting one) offset from each other along a line L inclined at an angle β with respect to the flat back face 164 of the tooth 16, between 1° and 5°, preferably equal to 2°, which allows to reduce the cutting force. Finally, it should be noted that each cutting sector 160 has a trapezoid form in cross section with an angle γ between consecutive cutting sectors of about 90°.

As can be noted from FIGS. 9A, 9B and 12, each tooth 16 has, below the cutting sectors 160, a draining face 162 having a hollow-shaped profile with a concavity facing the cavity 150 forming with it a containing and releasing seat of the removed shavings.

It should be specified that cutting teeth 16 or blades with one or more of the features as depicted and described even in combinations different to each other can be also adopted in apparatuses different from that shown and form the object of a separate patent application.

The collector assembly 19 can consist of a collector tub or plane eventually provided at the bottom of a draining opening.

The apparatus 10 can work dry or with lubricants of any type, or even with water, liquid or gaseous nitrogen, blow of room-temperature or cooled air.

Advantageously, the apparatus 10 works dry, so that the produced shavings are not contaminated, this also with high rotating speeds of the drum 15 and with a high productivity of about 200 Kg/h. If, working dry, the teeth 16 become suddenly worn, i.e., within a few dozen minutes with a productivity of 200 Kg/h, still working dry, the hourly productivity can be reduced by about ⅓, i.e., to about 60 Kg/h, reducing the rotating speed of the drum 15, so as to limit their degree of wear.

In any case, the apparatus 10, although in the face of a certain possible degree of wear of the teeth 16 and/or of a limited productivity, which also depends on the material of which the teeth 16 are made, can work dry to the advantage of the quality of the removed shavings.

Alternatively, it can work with lubrication or direct cooling at the contact between teeth 16 and pieces P to be treated.

As known, using a lubricant allows to reduce the wear of the teeth 16; however, residuals of lubricant can remain in the produced shavings, therefore lubricants or lubricants-refrigerants not involving problems of contamination and/or deterioration of the formed shavings will be selected.

According to a further alternative, the shavings removing point, or the contact point between teeth 16 and pieces P, can be cooled by using blows of room-temperature or cold air even at temperatures lower than 0° C., or blows of cold gaseous nitrogen, liquid nitrogen, or water. In such case, therefore, the apparatus 10 comprises jets (not depicted) to emit blows or jets of a cooling fluid selected between air, nitrogen, or water, disposed in proximity of the zone at which the drum 15 contacts the pieces P.

The operation of the apparatus 10 according to the present invention can be immediately understood by those skilled in the art in view of the description above and the attached figures.

The present invention further relates to a method for treating metal pieces, as already defined above, comprising the steps of:
a) providing metal pieces to be reduced into fragments;
b) reduce said metal pieces into fragments in a shavings form via chip removal;
c) in the case where the obtained fragments have apparent specific weight less than a threshold value, compacting said fragments into grit or sand with apparent specific weight close to or greater than said threshold value.

Metal pieces particularly mean pieces made of gold or silver. In such case, the threshold value of the bulk density is equal to 5.0 kg/dm³ for silver and to 10.0 kg/dm³ for gold, and the compacting step c) forms grit or sand with apparent specific weight between 4.0 kg/dm³ and 8.0 kg/dm³ for silver and between 8.0 kg/dm³ and 16.0 kg/dm³ for gold.

The metal pieces can be selected from the group comprising processing scraps, rods, or ingots not meeting the effective quality standards or scrapped from the production processes, processing scraps, large blocks, blocks, offcuts, crop-ends, shavings, or the like, anodes/cathodes used in electrochemical processes, or the like, new rods or however compliant with the effective standards.

The present invention also relates to a plant for treating metal pieces comprising an apparatus to reduce metal pieces into fragments via material removal (chip removal), by reducing them to fragments in a shavings form, and a compactor apparatus disposed downstream of said reducing apparatus and adapted to compact said fragments into grit or sand with apparent specific weight close to or greater than a threshold value as defined above. Advantageously, the reducing apparatus is an apparatus 10 as described above and claimed.

The apparatus to reduce metal pieces into fragments object of the present invention has the advantage of reducing metal pieces, particularly pieces of the type of rods or ingots having various form and size, to fragments in a shavings form adapted to be processed in subsequent processing for producing for example rods, ingots, coins, semi-finished products, or the like, without needing to proceed with the melting thereof, as instead is the case according to the known technologies (melting and casting), resulting in apparent energy and environment advantages.

The apparatus to reduce metal pieces into fragments thus conceived is susceptible of a number of modifications and variants, all falling within the invention; furthermore, all the details are replaceable by technically equivalent elements. In practice, the used materials, as well as s the size, can be any depending on the technical requirements.

1. An apparatus to reduce metal pieces into fragments, comprising a supporting and containing structure of:
a feeding assembly of metal pieces to be reduced into fragments;
a supporting plane adapted to receive the metal pieces fed by said feeding assembly and developing longitudinally between a first end and a second end axially opposite to each other;
a pusher assembly disposed in proximity of said first end of said supporting plane and adapted to exert, on the metal pieces fed and lying thereon, a thrust towards said second end along a thrust direction extending between said first end and said second end of said supporting plane;
a drum rotatably supported around its longitudinal axis in proximity of said second end of said supporting plane and provided with a plurality of teeth which are arranged on its outer side surface and which are adapted to remove fragments from said metal pieces pushed against it by said pusher assembly via chip removal, wherein said drum is rotationally drivable around its longitudinal axis by a motor element;
a presser assembly disposed above said supporting plane in proximity of said second end thereof and adapted to exert, on said metal pieces pushed by said pusher assembly, a pressure force with a component incident and directed towards said supporting plane;
a collector assembly of said fragments disposed below said drum.

2. The apparatus according to claim 1, further comprising, in proximity of said second end of said supporting plane, a removal assembly for removing from said drum offcuts-residuals of said metal pieces.

3. The apparatus according to claim 1, wherein said drum is disposed with its longitudinal axis parallel to said supporting plane and orthogonal to said thrust direction.

4. The apparatus according to claim 1, wherein said pusher assembly comprises at least one skid extending transversally to said supporting plane and which is slidable while lying thereon along said thrust direction and at least one linear actuator coupled to said skid to move it sliding along said thrust direction.

5. The apparatus according to claim 1, wherein said presser assembly comprises at least one block adapted to contact said metal pieces and which is coupled to the end of a respective stem, which stem is slidably supported along its axis in contrast with elastic pushing means on a plane orthogonal to said supporting plane and parallel to said thrust direction, wherein said stem is disposed with its axis orthogonal or incident to said supporting plane.

6. The apparatus according to claim 5, wherein said at least one block is rotatably coupled to said end of said stem around a joint axis parallel to said supporting plane and orthogonal to said thrust direction.

7. The apparatus according to claim 6, wherein said block is rotatably jointed around a first pin which is supported above said supporting plane between said first end thereof and said second end thereof and which is disposed with its axis parallel to said joint axis.

8. The apparatus according to claim 7, wherein said first pin is movably supported by said supporting and containing structure along at least one direction transversal to said supporting plane.

9. The apparatus according to claim 8, wherein said first pin is supported at the end of an inlet plate whose opposite end is rotatably jointed around a second pin which is fixed to said supporting and containing structure and which is disposed above said supporting plane between said first end and said second end and upstream of said first pin, wherein said inlet plate is rotatable around said second pin in contrast with respective elastic pushing means.

10. The apparatus according to claim 5, wherein said presser assembly comprises a plurality of said blocks distinct to each other which are disposed in succession side by side along a direction parallel to said supporting plane and orthogonal to said thrust direction.

11. The apparatus according to any one of the preceding claim 1, wherein said removal assembly comprises at least one bar disposed downstream of said second end of said supporting plane and provided with an upper surface forming a supporting surface of said metal pieces and said offcuts-residuals, wherein said at least one bar is movably coupled to said supporting and containing structure between a raised position, wherein it is side by side with said second end of said supporting plane with said upper surface thereof substantially coplanar and contiguous with the upper surface of said supporting plane to support said metal pieces or said offcuts-residuals, and at least one lowered position, wherein it is moved away from said second end of said supporting plane and disposed below said supporting plane clearing a space for dropping of said offcuts-residuals.

12. The apparatus according to claim 11, wherein said bar is held in said raised position thereof by respective holding means and is movably driven from said raised position thereof to said at least one lowered position thereof by the thrust exerted thereon by said offcuts-residuals dragged by said drum in contrast with the holding operation exerted by said holding means.

13. The apparatus according to claim 12, wherein said holding means comprise friction or elastic pushing means operating between said structure and said bar in the holding direction thereof in said raised position thereof, said bar being movably driven from said raised position thereof to said at least one lowered position thereof by the thrust exerted thereon by said offcuts-residuals dragged by said drum in contrast with the elastic force exerted by said elastic pushing means.

14. The apparatus according to claim 12, further comprising actuator elements adapted to bring back said bar from said at least one lowered position thereof to said raised position thereof.

15. The apparatus according to claim 1, wherein said teeth are arranged spaced to each other along a plurality of rows parallel to each other extending along helix lines.

16. The apparatus according to claim 1, wherein each of said teeth comprises a plurality of cutting sectors identical to each other arranged adjacent to each other and parallel to form a comb.

17. The apparatus according to claim 16, characterized in that each of said cutting sectors has a cutting profile protruding from said outer side surface of said drum of a maximum quota Q between 0.5 mm and 2.00 mm.

18. The apparatus according to claim 1, wherein each of said teeth is recessed in a respective containing cavity and has, below the respective cutting profile, a draining face having a hollow-shaped profile with a concavity facing said cavity forming a containing and releasing seat of said fragments.

19. The apparatus according to one or more of claim 16, wherein the front face of the cutting profile of each tooth is inclined at an angle between 5° and 15° with respect to the flat back face thereof.

20. The apparatus according to one or more of claim 16, wherein the cutting sectors of each tooth, plant viewed, have the outlet end offset from each other along a line L inclined at an angle, with respect to the flat back face of said tooth, between 1° and 5°.

21. The apparatus according to claim 16, wherein the cutting sectors of each tooth have a trapezoid form in cross section with an angle between consecutive cutting sectors of about 90°.

22. A method for treating metal pieces comprising the steps of:
providing metal pieces to be reduced into fragments;
reducing said metal pieces into fragments in a shavings form via chip removal;
if said fragments have apparent specific weight less than a defined threshold value, compacting said fragments into grit or sand with apparent specific weight close to or greater than said defined threshold value.

23. A plant for treating metal pieces made of gold, silver, or alloys thereof, comprising an apparatus to reduce metal pieces into fragments via chip removal, by reducing them to fragments in a shavings form, and a compactor apparatus disposed downstream of said reducing apparatus and adapted to compact said fragments into grit or sand with a desired apparent specific weight.

24. (canceled)

25. A plant for treating metal pieces made of gold, silver, or alloys thereof, comprising an apparatus to reduce metal pieces into fragments via chip removal according to claim 1, by reducing them to fragments in a shavings form, and a compactor apparatus disposed downstream of said reducing apparatus and adapted to compact said fragments into grit or sand with a desired apparent specific weight.
